(19) United States
(12) Patent Application Publication
(10) Pub. No.: US 2023/0057338 A1
(43) Pub. Date: Feb. 23, 2023

(54) CHORDOPHONE WITH SPEAKER FUNCTION

(71) Applicant: Daniel YEO, Incheon (KR)

(72) Inventor: Daniel YEO, Incheon (KR)

(21) Appl. No.: 17/820,919

(22) Filed: Aug. 19, 2022

(30) Foreign Application Priority Data
Aug. 23, 2021 (KR) 10-2021-0110968

(51) Int. Cl. G10D 1/08; G10D 3/14

(52) U.S. Cl. CPC G10D 1/08; G10D 3/14

(57) ABSTRACT

The present invention provides a chordophone including a body configured to have a top plate, a bottom plate, and a side plate connected to the top plate and the bottom plate, which comprises: a cut-out plate formed by cutting the bottom plate, and configured to have a grille formed on a portion penetrated of the cut-out plate; a bracket formed in a shape corresponding to the cut-out plate and configured to have a base plate coupled to an inner side of the cut-out plate; and a speaker unit configured to have a speaker installed in the bracket, a control unit for controlling an output of the speaker, and a communication module for allowing a sound source output from the speaker to be received from an external user terminal, in which the grille is formed in a size and shape corresponding to a diameter of a side on which a sound of the speaker is output, and a through-hole is formed penetrated on the base plate at a corresponding position to the grille and with a corresponding shape to a shape of the sound output side of the speaker.

### CROSS-REFERENCE TO RELATED APPLICATIONS

This application claims priority from Korean Patent Application No. 10-2021-0110968, filed on Aug. 23, 2021, which is hereby incorporated by reference for all purposes as if fully set forth herein.

### BACKGROUND OF THE INVENTION

### 1. Field of the Invention

The present invention relates to a chordophone with a speaker function, and more specifically, to a chordophone having a speaker function to enable violin practice and accompaniment function.

### 2. Description of the Related Art

Generally, string instruments are classified as instruments that make a sound by drawing a string with a bow, such as a violin, viola, cello, or contra bass and instruments that make a sound by flicking strings with fingers, such as a harp and guitar.

The present invention relates to a chordophone. A violin is a delicate instrument including 70 parts, unlike the simple-looking exterior. The violin, which has a body length of approximately 35.5 cm, has the form of a hollow box made of wood. The violin is configured to have a top plate, a bottom plate, and a side plate. Here, the top plate and the bottom plate of the body are both formed in a convex arch shape. The side plate that connects the top plate and the bottom plate has a different height for each instrument. For example, a typical height of the side plate connected to an upper body part of Stradivari violin is 2.8 cm, and a height of the side plate connected to a lower body part is 3.2 cm. The top plate is usually made of soft European spruce, the hard bottom plate and the side plate are made of maple wood. The violin's neck, peg box, and scroll are also made of maple wood and a finger board formed from the neck to the bridge is made of ebony. The top plate of the body is often made by attaching two plates, and the bottom plate is sometimes made of one piece of wood, or it is sometimes made by attaching two plates. For the sound as well as the strength of the violin, it is essential that the top and bottom plates are formed to have a rounded arch shape, and thus, the entire violin body is designed to amplify the best sound. Also, a sound post and a bass bar of the violin serve to support an inside of the instrument. The sound post, usually made of spruce, is disposed perpendicular between the top plate and the bottom plate, and is located in a lower right side of the bridge (It is not just below a right leg of the bridge, but it is placed on the same line as it is). The position of the sound post is an important factor in order to make the best sound of the violin. The bridge also needs to be located in the proper position to get a good sound, and it will be usually located parallel to an f-hole. The bass bar, made of spruce, is attached to a lower side of the top plate and is located under a left leg of the bridge, thereby enhancing the resonance of the bass (String Instruments (Encyclopedia of Musical Instruments, Hong-Rae Jeong and Won-Jin Song)).

### SUMMARY OF THE INVENTION

The present invention has been made in an effort to provide a chordophone with a speaker function and an accompaniment function that enables violin practice and accompaniment.

To achieve the aforementioned objectives, a chordophone according to the present invention, which includes a body configured to have a top plate, a bottom plate, and a side plate connected to the top plate and the bottom plate, includes: a cut-out plate formed by cutting the bottom plate, and configured to have a grille formed on a portion penetrated of the cut-out plate; a bracket formed in a shape corresponding to the cut-out plate and configured to have a base plate coupled to an inner side of the cut-out plate; and a speaker unit configured to have a speaker installed in the bracket, a control unit for controlling an output of the speaker, and a communication module for allowing a sound source output from the speaker to be received from an external user terminal, in which the grille is formed in a size and shape corresponding to a diameter of a side on which a sound of the speaker is output, and a through-hole is formed penetrated on the base plate at a corresponding position to the grille and with a corresponding shape to a shape of the sound output side of the speaker.

The speaker unit may include a power supply unit for applying power to the speaker, the control unit, and the communication module, and the power supply unit includes a charging terminal, and a second through-hole is formed on the base plate at a position corresponding to the charging terminal, and a third through-hole is formed on the cut-out plate at a position corresponding to the second through-hole.

The speaker unit may include a touch pad for controlling an operation of the speaker, and a touch part of the touch pad is provided in the bracket so as to be in contact with an inner side of the top plate.

An application (app) for controlling the speaker is installed in the user terminal, the app is executed, a lesson mode is selected, the number of playing measures is selected, and then when a performance video is executed, the control unit plays the performance video for the number of the selected playing measures, then transmits a video pause selection signal to the user terminal after the selected playing measures time elapse.

The present invention has been made in an effort to provide a chordophone with a speaker function and an accompaniment function that enables violin practice and accompaniment.

### BRIEF DESCRIPTION OF THE DRAWINGS

FIG. 1 is a view showing a front side of a violin according to an exemplary embodiment of the present invention;

FIG. 2 is a view showing a back side of the violin according to the exemplary embodiment of the present invention;

FIG. 3 is a view showing a lower part of the back side of the violin according to the exemplary embodiment of the present invention;

FIG. 4 is a view showing a front side of a display unit of the violin according to the exemplary embodiment of the present invention;

FIG. 5 is a view showing the lower part of the back side illustrating a state in which a cut-out plate of the violin has been removed according to the exemplary embodiment of the present invention;

FIG. 6 is a low-side perspective view showing a state in which a speaker unit is installed in a bracket of the violin according to the exemplary embodiment of the present invention;

FIG. 7 is a perspective view showing a state in which the speaker unit is installed in the bracket;

FIG. 8 is a perspective view of the bracket according to the exemplary embodiment of the present invention; and

FIG. 9 is a block diagram that outlines a configuration of the speaker unit.

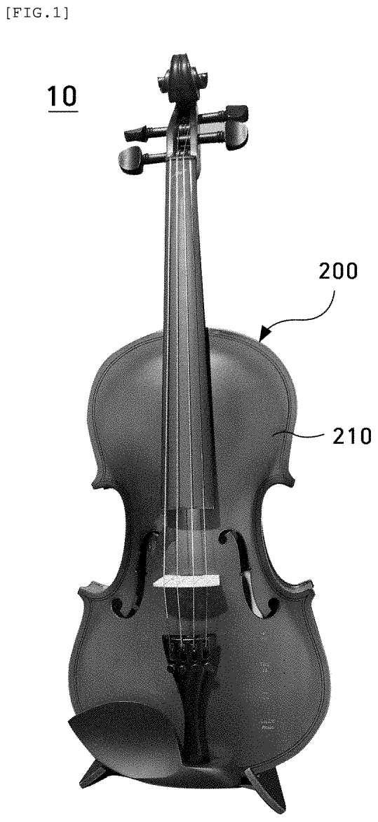

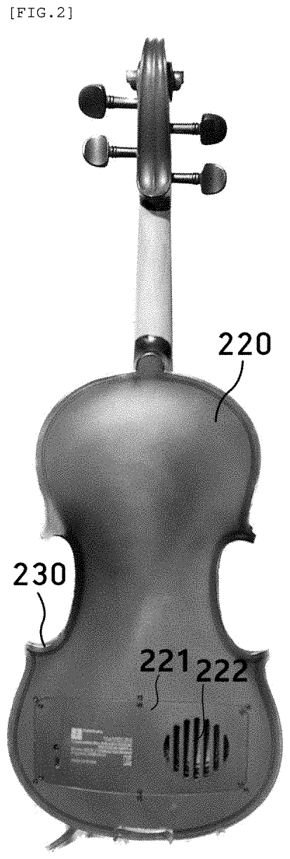

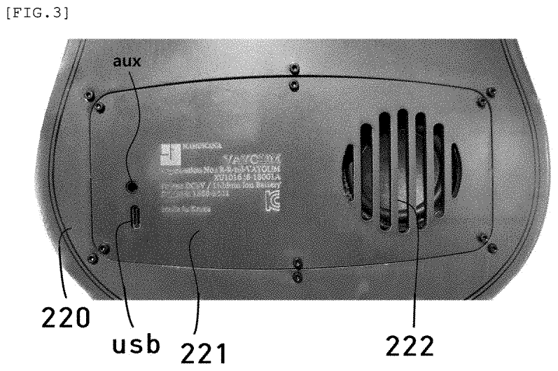

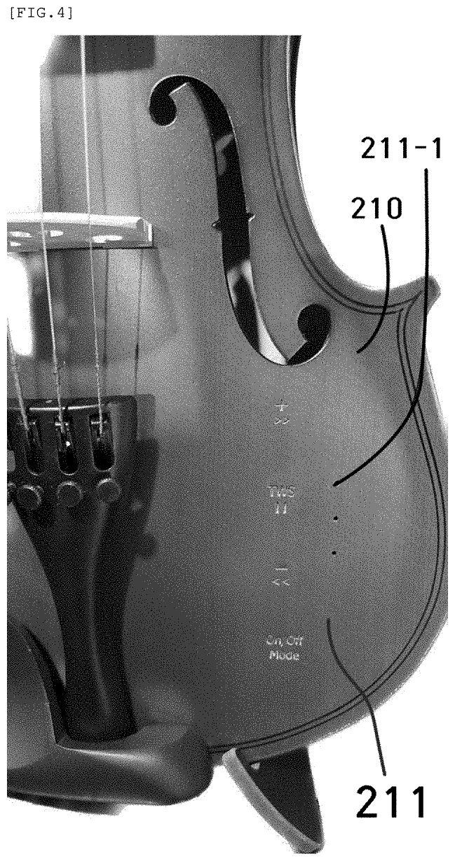

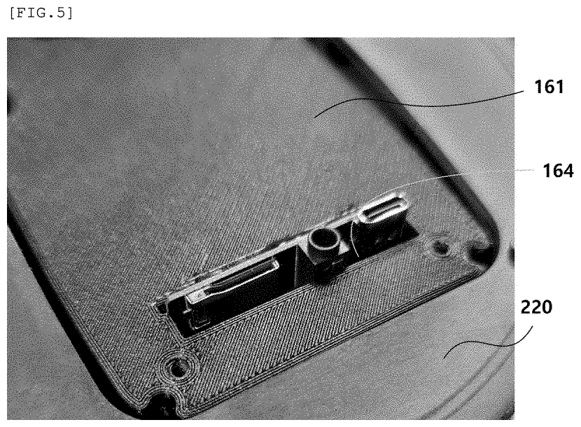

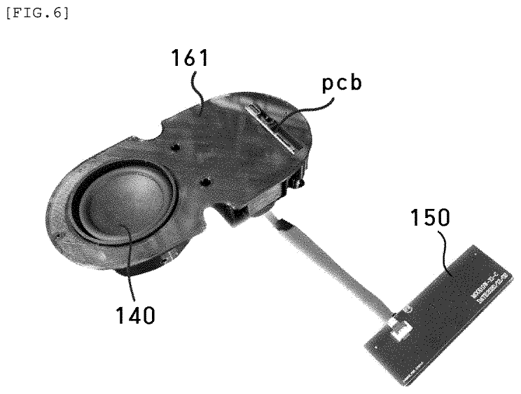

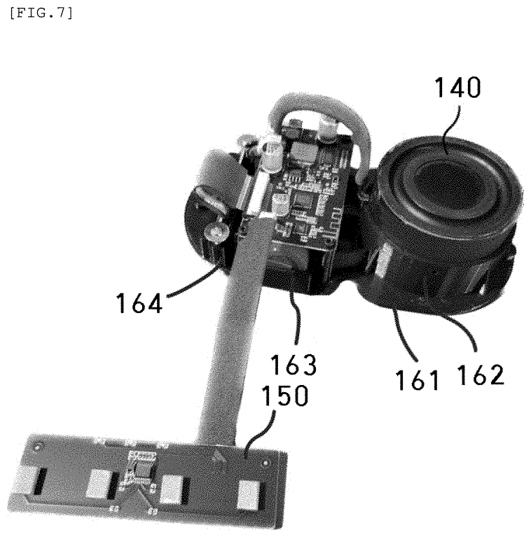

### DETAILED DESCRIPTION OF THE EMBODIMENTS

Hereinafter, an exemplary embodiment of the present invention will be described below in detail with reference to the accompanying drawings. However, the present invention is not limitedly applied to the exemplary embodiments described below, the technical features of the present invention are not limited by the exemplary embodiment described herein, and various modifications can be implemented within the technical scope of the present invention.

As a detailed description of an exemplary embodiment according to the present invention, the violin 10 of a chordophone will be described.

A chordophone according to an exemplary embodiment of the present invention is provided with a speaker unit 100 inside a body 200.

The chordophone may include a body 200 including a top plate 210, a bottom plate 220, and a side plate 230 connected to the top plate 210 and the bottom plate 220.

The bottom plate 220 is cut by laser cutting to form a cut-out plate 221. A portion of the cut-out plate 221 is penetrated to form a grille 222.

The top plate 210 is provided with a control unit 211. The control unit 211 is marked with play, pause, fast-forward, on/off, mode, TWS, etc. for a speaker control and a touch pad to be described below is provided close to a bottom of the control unit 211. Through-holes 211-1 are formed on one side of the control unit 211 so as to display a luminous status of a display LED indicating a power charge status, a communication connection status, an on/off status of the speaker unit 100.

The speaker unit 100 may include a speaker 140 for outputting a sound source, a communication module 120 for communicating wirelessly with an external user terminal, a memory 130 for which the sound source is stored, a touch pad 150 for transmitting a corresponding signal to the control unit 110 according to a touch of the control unit 211, and a power supply unit 170 that is chargeable from an external power.

A bracket 160 may include a base plate 161 formed in a shape corresponding to the cut-out plate 221 and coupled to the inner side of the cut-out plate 221.

The speaker unit 100 is provided on the opposite side of where the base plate 161 is in contact with the cut-out plate 221. The bracket 160 may further include a structure for each component of the speaker unit 100 to be coupled. The bracket 160 may be formed of a polymer material having shock resistance.

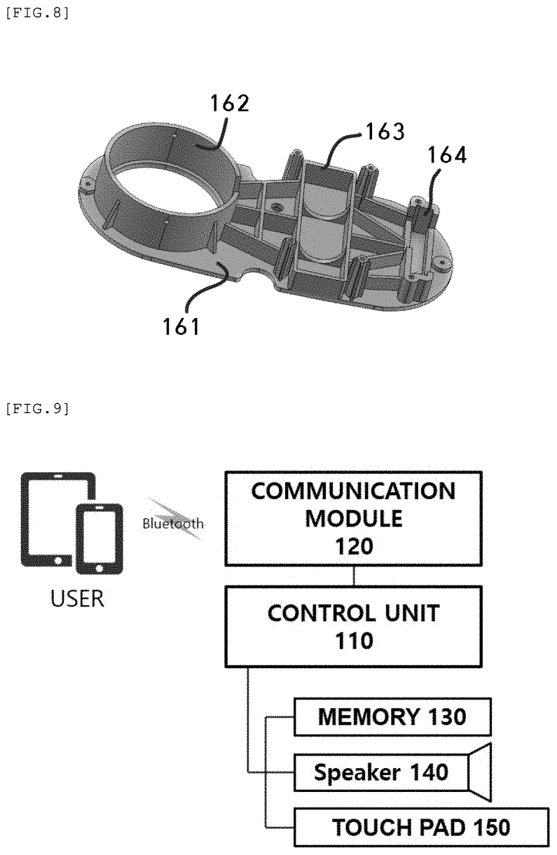

Referring to FIG. 8, a pipe-shaped speaker holder 162 is formed on the base plate 161 so as to hold a side of the speaker 140. The speaker holder 162 is formed to protrude through the base plate 161 toward an inner side of the base plate 161. Also, a battery holder 163 is formed protruding on the inner side of the base plate 161. A PCB holder 164 is formed by penetrating the base plate 161 and protruding on the inner side of the base plate 161 for the installation with an AUX, USB connection, or charging terminal.

A through-hole of the speaker holder 162 is formed to penetrate the base plate 161 at the position corresponding to the grille 222.

The grille 222 is formed in a size and shape corresponding to a diameter of a side on which a sound of the speaker is output.

The speaker unit 100 may include the speaker 140, the control unit, a communication module 120, and a power supply unit to apply power to the touch panel 150. The power supply unit may include a charging terminal. Also, a second through-hole 163 is formed on the base plate 161 at a position corresponding to the charging terminal, and a third through-hole 222 is formed on the cut-out plate 221 at a position corresponding to the second through-hole.

The speaker unit 100 may further include a touch pad 150 for controlling an operation of the speaker, and a touch part of the touch pad 150 is provided in the bracket 160 so as to be in contact with an inner side of the top plate.

In addition, an application(app) for controlling the speaker is installed in the user terminal, the app is executed, a lesson mode is selected, the number of playing measures is selected, and then when a performance video is executed, the control unit plays the performance video for the number of the selected playing measures, then transmits a video pause selection signal to the user terminal after the selected playing measures time elapse.

According to the exemplary embodiment of a chordophone of the present invention configured as above, first, a user selects a lesson mode with the user terminal or the control unit, and plays a video for playing the string instrument in the user terminal, and then selects the number of playing measures. The video is played during the selected playing measures, the string instrument playing sound source is simultaneously output through the speaker as much as corresponds to the selected measures, and then paused. Along the output sound source while play is paused, the user plays a string instrument. After the time corresponding to the selected measures has elapsed, the sound source play resumes. Thereby, the user listens to the sound source being played by the selected measures without pausing the sound source, and thus it is possible to obtain an advantageous effect that the user easily practices playing as much as the selected playing measures.

In addition, by selecting the accompaniment mode and then selecting the sound source corresponding to the accompaniment through the user terminal, the accompaniment corresponding to the playing of the string instrument is output through the speaker, so that it is also possible to obtain an advantageous effect that the user makes a solo performance with the accompaniment sound source that is output even if the user plays the string instrument only.

What is claimed is:

1. A chordophone, which comprises a body configured to have a top plate, a bottom plate, and a side plate connected to the top plate and the bottom plate, the chordophone comprising:
a cut-out plate formed by cutting the bottom plate, and configured to have a grille formed on a portion penetrated of the cut-out plate;
a bracket formed in a shape corresponding to the cut-out plate and configured to have a base plate coupled to an inner side of the cut-out plate; and
a speaker unit configured to have a speaker installed in the bracket, a control unit for controlling an output of the speaker, and a communication module for allowing a sound source output from the speaker to be received from an external user terminal,
wherein the grille is formed in a size and shape corresponding to a diameter of a side on which a sound of the speaker is output, and a through-hole is formed penetrated on the base plate at a corresponding position to the grille and with a corresponding shape to a shape of the sound output side of the speaker, and
wherein an application (app) for controlling the speaker is installed in the user terminal, the app is executed, a lesson mode is selected, the number of playing measures is selected, and then when a performance video is executed, the control unit plays the performance video for the number of the selected playing measures, then transmits a video pause selection signal to the user terminal after the selected playing measures time elapse.

2. The chordophone of claim 1, wherein the speaker unit comprises a power supply unit for applying power to the speaker, the control unit, and the communication module, and the power supply unit comprises a charging terminal,
wherein a second through-hole is formed on the base plate at a position corresponding to the charging terminal, and
wherein a third through-hole is formed on the cut-out plate at a position corresponding to the second through-hole.

3. The chordophone of claim 2, wherein the speaker unit comprises a touch pad for controlling an operation of the speaker, and a touch part of the touch pad is provided in the bracket so as to be in contact with an inner side of the top plate.

4. The chordophone of claim 1, wherein the bracket is formed of a polymer material having a shock resistance.
